(19) United States
(12) Patent Application Publication
(10) Pub. No.: US 2004/0027573 A1
(43) Pub. Date: Feb. 12, 2004

(54) Position measuring method, exposure method and system thereof, device production method

(76) Inventor: Akira Takahashi, Tokyo (JP)

Correspondence Address: Oliff & Berridge, P O Box 19928, Alexandria, VA, 22320, US

(21) Appl. No.: 10/433,401

(22) PCT Filed: Dec. 10, 2001
(86) PCT No.: PCT/JP01/10781

(30) Foreign Application Priority Data
Dec. 11, 2000 (JP) 2000-375798

(51) Int. Cl. G01B 11/00

(52) U.S. Cl. 356/401

(57) ABSTRACT

A position measuring method suppresses the influence of characteristics intrinsic to masks to improve the measurement accuracy of the mark position. A mask mark RM1 is positioned within an observation field of an observation system, and one of a plurality of fiducial marks FMa, FMb is selectively positioned within the observation field based on the characteristic of the mask mark RM1 with respect to an illumination beam, and the relative positional information of the mask mark RM1 and a fiducial mark WFM1 is obtained based on the observation results.

### TECHNICAL FIELD

The present invention relates to a position measuring method for detecting relative positions of a mark formed on a mask, and a mark formed on a substrate stage on which a substrate is mounted. More specifically, the present invention relates to a position measuring method used in an exposure method and exposure apparatus, used in a manufacturing process for devices, such as semiconductor devices and liquid crystal display devices.

The present application is based on Japanese Unexamined Patent Application No. 2000-375798, the content of which is incorporated herein by reference.

### BACKGROUND ART

In the manufacturing process of electronic devices such as semiconductor devices and liquid crystal display devices, multi-layer circuit patterns are overlapped on each other on a substrate (such as a wafer or a glass plate) in predetermined positions, while performing process operation. Therefore, when a circuit pattern of a second and subsequent layer is exposed on the substrate by the exposure apparatus, it is necessary to perform alignment of a pattern on a mask (or a reticle) with a pattern already formed on the substrate, highly accurately.

Therefore, an alignment mark is formed on the substrate, and the position of this alignment mark is measured by an observation system (alignment sensor) of the exposure apparatus to thereby accurately determine the position of the circuit pattern on the substrate. In this case, there is a method of directly detecting the positions of the mask and the circuit pattern on the substrate, to observe the alignment mark on the substrate via the mask, but generally, a method is adopted in which only the position of the alignment mark on the substrate is measured by the alignment sensor, and the position of the mask is separately measured, to perform superposition exposure by adjusting the relative positions of the mask and the circuit pattern, based on the accurate position information thereof.

As a position measuring method for measuring the position of a mask, it is normal to observe a beam generated from a mask mark formed on the mask via the observation system, and measure the position of the mask based on the observation result.

Recently, with high-density integration of integrated circuits, that is, with miniaturization of the circuit pattern, requirements for masking technology are increasing, and masks having various characteristics are now being used.

Therefore, the intensity of the beam generated from the mask mark becomes weak depending on the mask, and the image of the mask mark may not be observed with sufficient contrast. For example, a reticle (mask) referred to as a highly reflective reticle, has high reflectance of the mask mark with respect to general illumination beams, and the mask mark is observed with relatively high contrast. On the other hand, a reticle (mask) referred to as a low reflective reticle or a halftone reticle has low reflectance of the mask mark with respect to the illumination beams, and hence, even if it is attempted to observe the mask mark by using the reflected beam from the mask mark, the intensity of the reflected beam is weak, and the mask mark is likely to be observed with low contrast.

When the contrast of the observed mask mark is low, the measurement accuracy of the mark position may decrease. Moreover, an error is likely to occur, when the focal state of the observation system is adjusted with respect to the mask mark.

### DISCLOSURE OF THE INVENTION

In view of the above situation, it is an object of the present invention to provide a position measuring method which suppresses the influence of characteristics peculiar to masks to improve the measurement accuracy of the mark position.

It is another object of the present invention to provide an exposure method and an exposure apparatus which can improve the exposure accuracy, and a device manufacturing method which can improve the accuracy of a formed pattern.

The position measuring method in a first embodiment of the present invention is a position measuring method in which a mask mark (RM1) formed on a mask (R) and a fiducial mark (WFM1) formed on a fiducial member (WFB) provided on a substrate stage (WST) for mounting a substrate (W) thereon are illuminated by an illumination beam (IL), beams generated from both marks (RM1, WFM1) are observed by using an observation system (22A), and relative positions of the mask mark (RM1) and the fiducial mark (WFM1) are detected based on the observation result, wherein the fiducial mark (WFM1) includes a plurality of fiducial marks (FMa, FMb) having different characteristics with respect to the illumination beam (IL), and the method comprises: a first step of positioning the mask mark (RM1) within an observation field of the observation system (22A), a second step of selectively positioning any one of the plurality of fiducial marks (FMa, FMb) within the observation field based on the characteristic of the first mark (RM1) with respect to the illumination beam (IL); and a third step of illuminating the illumination beam (IL) onto the respective marks (RM1, FMa or FMb) respectively positioned in the first and the second steps to obtain relative position information of the mask mark (RM1) and the fiducial mark (WFM1), based on the result observed by the observation system (22A).

According to this position measuring method, the mask mark (RM1) on the mask (R) and the fiducial mark (WFM1) on the substrate stage (WST) are positioned within the observation field of the observation system (22A), and the relative positions of both marks (RM1, WFM1) are measured. At this time, the fiducial mark (WFM1) on the substrate stage (WST) comprises a plurality of fiducial marks (FMa, FMb) having different characteristics with respect to the illumination beam (IL), and one of these is positioned within the observation field based on the characteristic of the mask mark (RM1) with respect to the illumination beam (IL). Therefore, the influence due to the characteristic peculiar to the mask is suppressed, and the mask mark (RM1) is observed with high contrast, by selecting the fiducial mark (WFM1) positioned within the observation field from the plurality of fiducial marks (FMa, FMb). As a result, the relative positions thereof can be accurately detected.

In this case, as in a second embodiment of the present invention, the plurality of fiducial marks (FMa, FMb) may include a first fiducial mark (FMa) in which a mark pattern (MPa) is formed of chromium on a base area formed of glass, and a second fiducial mark (FMb) in which a mark pattern (MPb) is formed of glass on a base area formed of chromium. As a result, in the first fiducial mark (FMa), beams having weak intensity are generated from the base area formed of glass, and strong beams are generated from the mark pattern (MPa) formed of chromium. In the second fiducial mark (FMb), strong beams are generated from the base area formed of chromium, and weak beams are generated from the mark pattern (MPb) formed of glass.

In this case, as in a third embodiment of the present invention, in the second step, when the reflectance of the mask mark (RM1) is not lower than a predetermined reflectance, the first fiducial mark (FMa) is selectively positioned within the observation field, and when the reflectance of the mask mark (RM1) is lower than the predetermined reflectance, the second fiducial mark (FMb) is selectively positioned within the observation field. As a result, when the reflectance of the mask mark (RM1) is not lower than the predetermined reflectance, strong beams are generated from the mask mark (RM1), and weak beams are generated from the base area of the first fiducial mark (FMa). Thereby, the mask mark (RM1) is observed with high contrast. On the other hand, when the reflectance of the mask mark (RM1) is lower than the predetermined reflectance, though the beams generated from the mask mark (RM1) are weak, since strong beams are generated from the base area of the second fiducial mark (FMb), the mask mark (RM1) is observed with high contrast.

A position measuring method in a fourth embodiment of the present invention is a position measuring method in which a mask mark (RM1) formed on a mask (R) mounted on a mask stage (RST) and a fiducial mark (WFM1) formed on a fiducial member (WFB) provided on a substrate stage (WST) are illuminated by an illumination beam (IL), beams generated from both marks (RM1, WFM1) are observed by using an observation system (22A), and relative positions of the mask mark (RM1) and the fiducial mark (WFM1) are detected based on the observation result, the method comprising: a first step of positioning a first mark (RM1 or RFM1) on the mask stage (RST) within the observation field of the observation system (22A); a second step of positioning an area arranged on the substrate stage (WST) side with respect to the mask stage (RST) and observed together with the first mark (RM1 or RFM1) by the observation system (22A) selectively within the observation field, based on the characteristic of the first mark (RM1 or RFM1) with respect to the illumination beam (IL); and a third step of detecting the first mark (RM1 or RFM1) via the observation system (22A) by using the illumination beam (IL) after the first step and the second step, to thereby detect the focal state of the observation system (22A) with respect to the first mark (RM1 or RFM1).

According to this position measuring method, after the first mark (RM1 or RFM1) on the mask stage (RST) and the fiducial mark (WFM1) on the substrate stage (WST) are positioned within the observation field of the observation system (22A), the first mark (RM1 or RFM1) is detected, and the focal state of the observation system (22A) with respect to the first mark (RM1 or RFM1) is detected. At this time, the area on the substrate stage (WST) side observed together with the first mark (RM1 or RFM1) by the observation system (22A) is positioned selectively within the observation field based on the characteristic of the first mark (RM1 or RFM1) with respect to the illumination beam (IL). Therefore, by selecting the area on the substrate stage side positioned within the observation field so that the contrast of the first mark (RM1 or RFM1) increases, the influence due to the characteristic peculiar to the mask is suppressed, and the first mark (RM1 or RFM1) is observed with higher contrast. Therefore, it becomes possible to accurately detect the focal state of the observation system (22A) with respect to the first mark (RM1 or RFM1).

In this case, as in a fifth embodiment of the present invention, the fiducial mark (WFM1) comprises a plurality of fiducial marks (FMa, FMb) having different characteristics with respect to the illumination beam (IL), and the area positioned within the observation field in the second step may be any one fiducial mark of the plurality of fiducial marks (FMa, FMb). In this case, by selecting the fiducial mark (WFM1) to be positioned within the observation field from a plurality of fiducial marks (WFM1, WFM2) based on the characteristic of the first mark (RM1 or RFM1) with respect to the illumination beam (IL), so that the contrast of the first mark (RM1 or RFM1) increases, the first mark (RM1 or RFM1) is observed with high contrast.

In this case, as in a sixth embodiment of the present invention, the plurality of fiducial marks (FMa, FMb) may include the first fiducial mark (WFM1) in which a mark pattern (MP1) formed of chromium is formed on a base area formed of glass, and a second fiducial mark (WFM2) in which a mark pattern (MPb) formed of glass is formed on a base area formed of chromium. In this case, as in the invention in the second embodiment, in the first fiducial mark (FMa), beams having weak intensity are generated from the base area formed of glass, and strong beams are generated from the mark pattern (MPa) formed of chromium. In the second fiducial mark (FMb), strong beams are generated from the base area formed of chromium, and weak beams are generated from the mark pattern (MPb) formed of glass.

In the position measuring method in the fourth or fifth embodiment of the present invention, as in a seventh embodiment, since the first mark is the mask mark (RM1), the mask mark (RM1) is observed with high contrast, and the focal state of the observation system (22A) with respect to the mask mark (RM1) is accurately detected.

In the position measuring method in the fourth embodiment, as in the invention according to an eighth embodiment, the area positioned within the observation field in the second step may be a board (BS) on which the substrate stage (WST) is mounted. As a result, the focal state of the observation system (22A) with respect to the first mark (RM1 or RFM1) can be detected, during replacement of the substrate (W).

In the position measuring method in the eighth embodiment, as in the invention according to a ninth embodiment, when the replacement operation of the substrate (W) to be mounted on the substrate stage (WST) is executed, the detection operation of the focal state of the observation system (22A) with respect to the first mark (RM1 or RFM1) may be performed. In this case, by performing the detection operation of the focal state during the replacement operation of the substrate (W), the throughput can be improved.

In this case, as in the invention according to a tenth embodiment, since the first mark is the mask mark (RM1), the mask mark (RM1) and a partial area on the board (BS) are positioned within the observation field, and the focal state of the observation system (22A) with respect to the mask mark (RM1) is detected based on the detection result of the mask mark (RM1).

In the position measuring method of the ninth embodiment, as in the invention according to an eleventh embodiment, since the first mark is a fiducial mark (RFM1) formed on a fiducial member (RFB) provided on the mask stage (RST), the fiducial mark (RFM1) and the board (BS) are positioned within the observation field, and the focal state of the observation system (22A) with respect to the fiducial mark (RFM1) is detected based on the detection result of the fiducial mark (RFM1).

In the position measuring method according to any one of the first to the eleventh embodiments of the present invention, as in the invention according to a twelfth embodiment, the characteristic may include a reflectance characteristic with respect to the illumination beam (IL).

The invention according to a fourteenth embodiment of the present invention is a position measuring method in which a mask mark (RM1) formed on a mask (R) mounted on a mask stage (RST) and a fiducial mark (WFM1) formed on a fiducial member (WFB) provided on a substrate stage (WST) are illuminated by an illumination beam (IL), beams generated from both marks (RM1, WFM1) are observed by using an observation system (22A), and relative positions of the mask mark (RM1) and the fiducial mark (WFM1) are detected based on the observation result, the method comprising: a first step of replacing a substrate (W) mounted on the substrate stage (WST) with another substrate; and a second step of detecting a first mark (RM1 or RFM1) on the mask stage (RST) via the observation system (22A) by using the illumination beam (IL) while performing the replacement operation of the substrate (W) in the first step, to thereby detect the focal state of the observation system (22A) with respect to the first mark (RM1 or RFM1).

According to this position measuring method, while the substrate (W) mounted on the substrate stage (WST) is being replaced with another substrate, the focal state of the observation system (22A) with respect to the first mark (RM1 or RFM1) is detected, thereby enabling improvement of the throughput.

In this case, as in the invention of a fifteenth embodiment, the first step is carried out without accompanying a mask replacement operation for replacing a mask (R) mounted on the mask stage (RST) by another mask, and the second step is executed every time the replacement operation of the substrate (W) is performed for a predetermined number of times.

In the position measuring method in the fourteenth or fifteenth embodiment, as in the invention according to a sixteenth embodiment, when the first mark (RM1 or RFM1) is detected in the second step, the board (BS) on which the substrate stage (WST) is mounted may be positioned within the observation field. In this case, the first mark (RM1 or RFM1) and the board (BS) are positioned within the observation field, and based on the detection result of the first mark (RM1 or RFM1) at that time, the focal state of the observation system (22A) with respect to the first mark (RM1 or RFM1) is detected.

Moreover, in the position measuring method according to any one of the first to the sixteenth embodiment, as in the invention according to a seventeenth embodiment, the first mark may be one of the mask mark (RM1) and the fiducial mark (RFM1) formed on the fiducial member (RFB) provided on the mask stage (RST).

The invention according to a twentieth embodiment of the present invention is a position measuring method in which a mask mark (RM1) formed on a mask (R) mounted on a mask stage (RST) and a first fiducial mark (WFM1) formed on a first fiducial member (WFB) provided on a substrate stage (WST) are illuminated by an illumination beam (IL), beams generated from both marks (RM1, WFM1) are observed by using an observation system (22A), and relative positions of the mask mark (RM1) and the first fiducial mark (WFM1) are detected based on the observation result, the method comprising: a first step of illuminating the illumination beam (IL) onto the first fiducial mark (WFM1), and detecting the focal state of the observation system (22A) with respect to the first fiducial mark (WFM1) based on the observation result by the observation system (22A); a second step of illuminating the illumination beam (IL) onto a second fiducial mark (RFM1) formed on a second fiducial member (RFB) provided on the mask stage (RST), and detecting the focal state of the observation system (22A) with respect to the second fiducial mark (RFM1) based on the observation result by the observation system (22A); a third step of replacing a substrate (W) mounted on the substrate stage (WST) with another substrate; a fourth step of detecting the second fiducial mark (RFM1) via the observation system (22A) by using the illumination beam (IL), while performing the replacement operation of the substrate (W) in the third step, to detect the focal state of the observation system (22A) with respect to the second fiducial mark (RFM1); and a fifth step of adjusting the focal state of the observation system (22A) based on the focal state respectively detected in the first, second and fourth steps.

According to this position measuring method, at first, the focal state of the observation system (22A) with respect to the first fiducial mark (WFM1) on the substrate stage (WST) is detected. Here, since a plane where the mask mark (RM1) is formed on the mask (R), and a plane where the first fiducial mark (RFM1) is formed on the substrate stage (WST) are arranged in a conjugate relationship, the detection of the focal state of the observation system (22A) with respect to the first fiducial mark (WFM1) corresponds to the detection of the focal state of the observation system (22A) with respect to the mask mark (RM1).

The focal state of the observation system (22A) with respect to the second fiducial mark (RFM1) on the mask stage (RST) is detected next. Thereby, it becomes possible to determine the relation between the focal state of the observation system (22A) with respect to the first fiducial mark (WFM1) and the focal state of the observation system (22A) with respect to the second fiducial mark (RFM1).

Thereafter, by detecting the focal state of the observation system (22A) with respect to the second fiducial mark (RFM1), the focal state of the observation system (22A) with respect to the mask mark (RM1) at that point in time can be calculated, based on the detection results of the respective focal states.

In this case, at the time of calculating the focal state, since it is not necessary to observe the mask mark (RM1), a decrease in the measurement accuracy due to the characteristic peculiar to the mask (R) can be avoided, and the focal state of the observation system (22A) can be adjusted accurately. While performing the replacement operation of the substrate (W), detection of the focal state of the observation system (22A) is carried out, and hence a decrease in throughput can be suppressed.

In this case, as in the invention according to a twenty-first embodiment, the second step is performed after the focus of the observation system (22A) is adjusted with respect to the first fiducial mark (WFM1) based on the detection result in the first step. As a result, the relation between the focal state of the observation system (22A) with respect to the first fiducial mark (WFM1), and the focal state of the observation system (22A) with respect to the second fiducial mark (RFM1) can be easily obtained.

In the position measuring method according to the twentieth or twenty-first embodiment, as in the invention according to a twenty-second embodiment, the method further comprises a sixth step of obtaining the relation between the focal state detected in the first step and the focal state detected in the second step, and in the fifth step, the focal state of the observation system (22A) is adjusted based on the relation obtained in the sixth step and the focal state detected in the fourth step.

The invention according to a twenty-third embodiment is an exposure method, wherein based on the relative positions measured by using the position measuring method according to any one of the first to the twenty-second embodiments, the substrate (W) is positioned at the exposure position, and a pattern on the mask (R) is transferred onto the positioned substrate (W).

According to this exposure method, since the relative positions can be detected accurately, it becomes possible to accurately position the substrate (W) based on the position, to improve the exposure accuracy.

The invention according to a twenty-fourth embodiment is a device manufacturing method, comprising a step of transferring a device pattern formed on a mask (R) onto a substrate (W), by using the exposure method according to the twenty-third embodiment.

According to this device manufacturing method, the accuracy of the formed pattern can be improved by the improvement in the exposure accuracy.

The invention according to a twenty-fifth embodiment is an exposure apparatus in which a mask mark (RM1) formed on a mask (R) and a fiducial mark (WFM1) formed on a fiducial member (WFB) provided on a substrate stage (WST) for mounting a substrate (W) thereon are illuminated by an illumination beam (IL), beams generated from both marks (RM1, WFM1) are observed by using an observation system (22A), and relative positions of the mask mark (RM1) and the fiducial mark (WFM1) are detected based on the observation result, to transfer a pattern formed on the mask (R) onto a substrate (W) positioned based on the relative positions, wherein the fiducial mark (WFM1) includes a plurality of fiducial marks (FMa, FMb) having different characteristics with respect to the illumination beam (IL), and the apparatus comprises: a first drive system (26A) which positions the mask mark (RM1) within an observation field of the observation system (22A), a second drive system (25) which selectively positions any one of the plurality of fiducial marks (FMa, FMb) within the observation field based on the characteristic of the first mark (RM1) with respect to the illumination beam (IL), and a computing section (13) which illuminates the illumination beam (IL) onto the respective marks (RM1, FMa or FMb) respectively positioned by the first and second drive systems (26A, 25) to obtain relative position information of the mask mark (RM1) and the fiducial mark (WFM1), based on the result observed by the observation system (22A).

By this exposure apparatus, the position measuring method according to the first embodiment can be executed.

The invention according to a twenty-sixth embodiment is an exposure apparatus in which a mask mark (RM1) formed on a mask (R) mounted on a mask stage (RST) and a fiducial mark (WFM1) formed on a fiducial member (WFB) provided on a substrate stage (WST) are illuminated by an illumination beam (IL), beams generated from both marks (RM1, WFM1) are observed by using an observation system (22A), and relative positions of the mask mark (RM1) and the fiducial mark (WFM1) are detected based on the observation result, to transfer a pattern formed on the mask (R) onto a substrate (W) positioned based on the relative positions, wherein the fiducial mark (WFM1) includes a plurality of fiducial marks (FMa, FMb) having different characteristics with respect to the illumination beam (IL), and the apparatus comprises: a first drive system (26A) which positions the mask mark (RM1) within an observation field of the observation system (22A), a second drive system (25) which selectively positions any one of the plurality of fiducial marks (FMa, FMb) within the observation field based on the characteristic of the first mark (RM1) with respect to the illumination beam (IL), and a focus detection system (70) which after positioning by means of the first and second drive systems (26A, 25), detects the mask mark (RM1) via the observation system (22A) by using the illumination beam (IL), to detect the focal state of the observation system (22A) with respect to the mask mark (RM1).

By this exposure apparatus, the position measuring method according to the fifth embodiment can be executed.

The invention according to a twenty-ninth embodiment is an exposure apparatus in which a mask mark (RM1) formed on a mask (R) mounted on a mask stage (RST) and a fiducial mark (WFM1) formed on a fiducial member (WFB) provided on a substrate stage (WST) are illuminated by an illumination beam (IL), beams generated from both marks (RM1, WFM1) are observed by using an observation system (22A), and relative positions of the mask mark (RM1) and the fiducial mark (WFM1) are detected based on the observation result, to transfer a pattern formed on the mask (R) onto a substrate (W) positioned based on the relative positions, and the apparatus comprises: a substrate replacing apparatus which replaces a substrate (W) mounted on the substrate stage (WST) with another substrate; and a focus detection system (70) which detects a first mark (RM1 or RFM1) on the mask stage (RST) via the observation system (22A) by using the illumination beam (IL) while performing the replacement operation of the substrate (W) by the substrate replacing apparatus, to thereby detect the focal state of the observation system (22A) with respect to the first mark (RM1 or RFM1).

By this exposure apparatus, the position measuring method according to the fourteenth embodiment can be executed.

The invention according to a thirty-third embodiment is an exposure apparatus in which a mask mark (RM1) formed on a mask (R) mounted on a mask stage (RST) and a first fiducial mark (WFM1) formed on a first fiducial member (WFB) provided on a substrate stage (WST) are illuminated by an illumination beam (IL), beams generated from both marks (RM1, WFM1) are observed by using an observation system (22A), and relative positions of the mask mark (RM1) and the first fiducial mark (WFM1) are detected based on the observation result, to transfer a pattern formed on the mask (R) onto a substrate (W) positioned based on the relative positions, the exposure apparatus comprising: a focus detection system (70) which detects a predetermined mark via the observation system (22A) by using the illumination beam (IL) to detect the focal state of the observation system (22A) with respect to the predetermined mark; a memory section (13) which obtains the relation between the focal4 state of the observation system (22A) with respect to the first fiducial mark (WFM1) detected by using the focus detection system (70) and the focal state of the observation system (22A) with respect to a second fiducial mark (RFM1) formed on a second fiducial mark (WFM1) member (RFB) provided on the mask stage (RST) and stores the relation; a substrate replacing apparatus which replaces the substrate (W) mounted on the substrate stage (WST) with another substrate; and a focus adjusting system (55) which adjusts the focal state of the observation system (22A) by using the relation stored in the memory section (13) and the focal state of the observation system (22A) with respect to the second fiducial mark (RFM1) detected by using the focus detection system (70), while performing the replacement operation of the substrate (W) by the substrate replacing apparatus.

By this exposure apparatus, the position measuring method according to the twentieth embodiment can be executed.

The invention according to a thirty-fourth embodiment is an exposure apparatus in which a mask mark (RM1) formed on a mask (R) and a fiducial mark (WFM1) formed on a fiducial member (WFB) provided on a substrate stage (WST) are illuminated by an illumination beam (IL), beams generated from both marks (RM1, WFM1) are observed by using an observation system (22A), and relative positions of the mask mark (RM1) and the fiducial mark (WFM1) are detected based on the observation result, to transfer a pattern formed on the mask (R) onto a substrate (W) positioned based on the relative positions, wherein a plurality of fiducial marks (FMa, FMb) having a different reflectance with respect to the illumination beam (IL) is formed on the fiducial member (WFB).

According to this exposure apparatus, since it comprises the fiducial member (WFB), on which the plurality of fiducial marks (FMa, FMb) having a different reflectance with respect to the illumination beam (IL) is formed, the influence due to the characteristic peculiar to a mask (R) can be suppressed, by positioning any one of the plurality of fiducial marks (FMa, FMb) within the observation field based on the characteristic of the mask mark (RM1) with respect to the illumination beam (IL), and the mask mark (RM1) can be observed with higher contrast, thereby enabling accurate detection of the relative positions.

### BRIEF DESCRIPTION OF DRAWINGS

FIG. 1 is a diagram showing a position measuring method according to the present invention.

FIG. 2 is a diagram showing a schematic configuration of an exposure apparatus according to the present invention.

FIG. 3 is a plan view showing a reticle mark.

FIG. 4 is a plan view showing a wafer fiducial mark.

FIG. 5 is a diagram showing a main part of FIG. 2 in an enlarged scale.

FIG. 6 is a flowchart showing the procedure of the operation of the exposure apparatus.

FIG. 7 is a flowchart showing one example of the procedure of a focus adjusting operation in reticle alignment.

FIG. 8 is a diagram showing the situation of an observed reticle mark, designating a stage board as a base.

FIG. 9 is a flowchart showing another example of the procedure of the focus adjusting operation in reticle alignment.

FIG. 10 is a diagram showing the situation of a reticle stage provided with a fiducial board.

FIG. 11 is a flowchart showing another example of the procedure of the focus adjusting operation in reticle alignment.

### BEST MODE FOR CARRYING OUT THE INVENTION

Embodiments of the present invention will be described below with respect to the drawings.

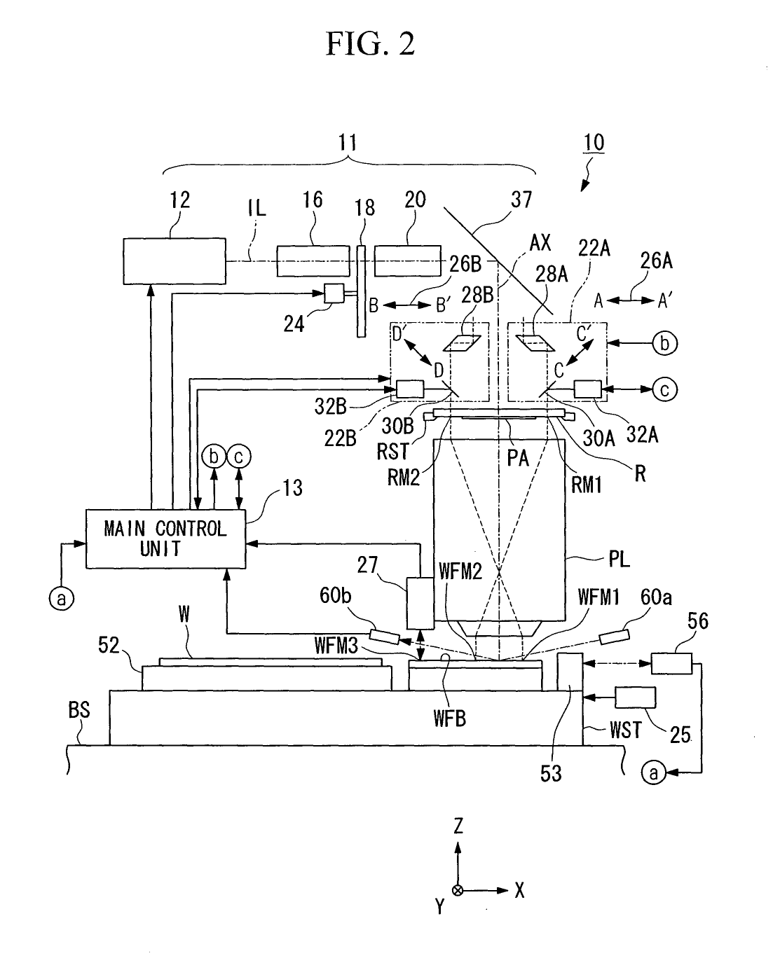

FIG. 2 schematically shows the configuration of a reduction projection type exposure apparatus 10 for manufacturing semiconductor devices preferably used in the embodiment. This reduction projection type exposure apparatus 10 is a reduction projection type scanning exposure apparatus (scanning exposure apparatus) which projects a pattern formed on a reticle R as a mask onto a shot area of a wafer W as a photosensitive substrate, via a projection optical system PL, by a step and scan method (a method for projecting and exposing a mask pattern onto a substrate by synchronously shifting the mask and the photosensitive substrate in a direction opposite to each other, while projecting a slit-form pattern).

This projection exposure apparatus 10 comprises an illumination system 11 including a light source 12, a reticle stage RST for holding a reticle R, a projection optical system PL for projecting a pattern image formed on the reticle R onto a wafer W, a wafer stage WST as a substrate stage for holding the wafer W, reticle alignment microscopes 22A and 22B as a pair of observation means, a wafer alignment sensor 27, a main focus detection system (60a, 60b), a control system and the like.

The illumination system 11 includes the light source 12 consisting of for example an excimer laser, an illuminance equalizing optical system 16 including a beam shaping lens, an optical integrator (fly-eye lens) and the like, an illumination system aperture diaphragm plate (revolver) 18, a relay optical system 20, a reticle blind (not shown), a bending mirror 37, a condenser lens (not shown) and the like. Here, the respective constituents of the illumination system 11 will be described, together with the operation thereof. The illumination beam IL (excimer laser beam (KrF, ArF) etc.) emitted from the light source 12 is subjected to equalization of the beam by the illuminance equalizing optical system 16 and reduction of speckle. The emission of laser pulses from the light source 12 is controlled by a main control unit 13 described later. An extra-high pressure mercury lamp may be used for the light source 12, and in this case, the emission line in uv, such as g-line and i-line is used as the illumination beam, and opening and closing of a shutter (not shown) is controlled by the main control unit 13.

The illumination system aperture diaphragm plate 18 comprising a disc member is arranged at an outlet portion of the illuminance equalizing optical system 16. On this illumination system aperture diaphragm plate 18, there are arranged at substantially equiangular spacing, an aperture diaphragm comprising, for example, a normal circle aperture, an aperture diaphragm for decreasing a σ value, being a coherence factor, comprising a small circle aperture, an aperture diaphragm in a ring shape for illuminating the zones, and a deformed aperture diaphragm obtained by arranging a plurality of apertures eccentrically for a deformed light source method (none of these are shown). This illumination system aperture diaphragm plate 18 is rotated by a drive system 24 such as a motor, controlled by the main control unit 13, and as a result, one of the aperture diaphragms is selectively set on the optical axis of the illumination beam IL.

The relay optical system 20 is installed on the optical axis of the illumination beam IL at the rear of the illumination system aperture diaphragm plate 18, via a blind (not shown). The plane where the blind is installed has a conjugate relation with the reticle R. The bending mirror 37 for reflecting the illumination beam IL having passed through the relay optical system 20 toward the reticle R is arranged on the optical axis of the illumination beam IL after the relay optical system 20, and the condenser lens (not shown) is arranged on the optical axis of the illumination beam IL after the mirror 37. Therefore, when passing through the relay optical system, the illumination beam IL is bent vertically downward by the mirror 37, with the illumination area of the reticle R being regulated (restricted) by the blind (not shown), to thereby illuminate a pattern area PA in the illumination area of the reticle R with uniform illuminance, via the condenser lens (not shown).

The reticle R is mounted on the reticle stage RST, and held by vacuum attraction via a vacuum chuck or the like (not shown). The reticle stage RST is formed so as to be able to move two-dimensionally within a horizontal plane (XY plane), and after the reticle R is mounted on the reticle stage RST, positioning is carried out so that the central point of the pattern area PA on the reticle R coincides with the optical axis AX. Such positioning operation of the reticle stage RST is performed by controlling the drive system (not shown) by the main control unit 13. The reticle alignment for initialization of the reticle R will be described in detail later. The reticle R is appropriately replaced by a reticle replacing apparatus (not shown) and used.

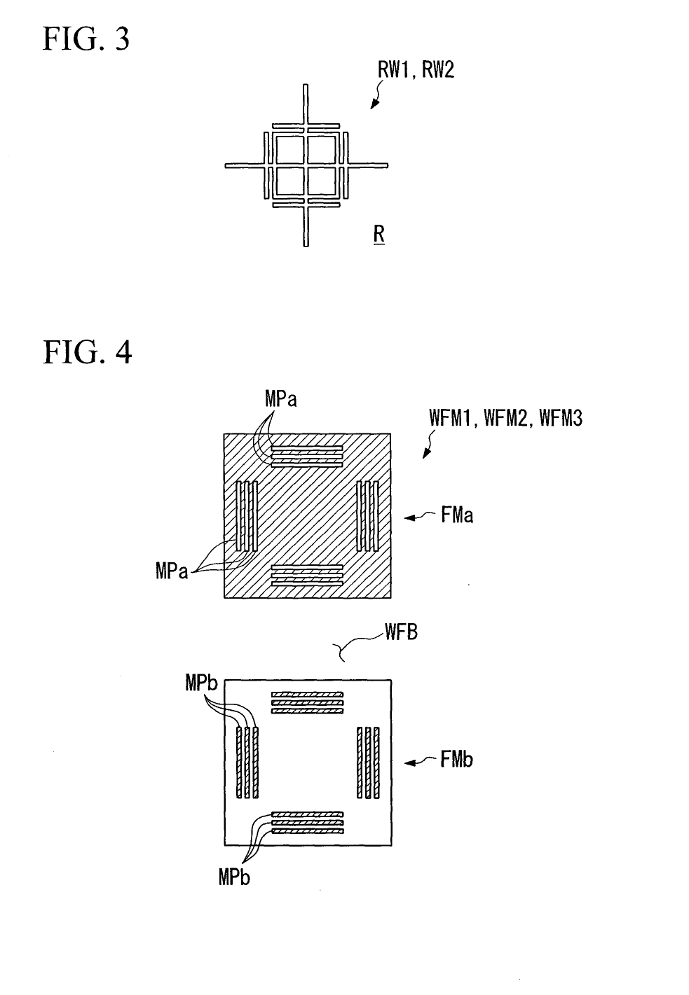

FIG. 3 shows a configuration example of the reticle marks RM1, RM2 on the reticle R used for reticle alignment and the like. The reticle marks RM1, RM2 are provided outside of the pattern area on the plane arranged below the reticle R, and are transferred onto a glass plate, being a parent material of the reticle R, based on design data, by for example a pattern generator or an EB exposure apparatus, and formed in a predetermined shape as a shading section comprising chromium.

Returning to FIG. 2, the projection optical system PL is formed of a plurality of lens elements having a common optical axis AX in the Z axis direction, arranged so as to be a telecentric optical arrangement on opposite sides. For the projection optical system PL, one having a projection magnification of for example ¼ or ⅕ is used. Therefore, as described above, when the illumination area on the reticle R is illuminated by the illumination beam IL, the pattern formed on a pattern face of the reticle R is projected in a reduced size onto the wafer W, on the surface of which a resist (photosensitive material) is applied, by the projection optical system PL, so that a reduced image of the circuit pattern on the reticle R is transferred to one shot area on the wafer W. However, in FIG. 2, for convenience of explanation, a case other than the state at the time of exposure when the reticle pattern image is formed on the wafer W is shown.

The wafer stage WST is mounted on the board (stage board BS) arranged below the projection optical system PL. This wafer stage WST actually comprises an XY stage two-dimensionally movable within the horizontal plane (XY plane), and a Z stage mounted on the XY stage and slightly movable in a direction of the optical axis (in the Z direction). In FIG. 2, however, these stages are shown representatively as the wafer stage WST. In the description below, it is assumed that this wafer stage WST is driven in the two-dimensional XY direction along the upper face of the stage board BS, and in the direction of the optical axis AX within a fine range (for example about 100 μm), by the drive system 25. The surface of the stage board BS is machined smoothly, and is uniformly applied with plating of a substance having a low reflectance (black chromium or the like).

The wafer W is fixed on the wafer stage WST via the wafer holder 52 by vacuum attraction or the like. The two-dimensional position of the wafer stage WST is detected at all times with a predetermined resolution (for example, about 1 nm) by a laser interferometer 56 via a movable mirror 53 fixed on the wafer stage WST, and the output of the laser interferometer 56 is supplied to the main control unit 13. The drive system 25 is controlled by the main control unit 13, and by means of such a closed loop control system, for example, when the transfer exposure (scanning exposure) of the pattern on the reticle R onto one shot area on the wafer W is finished, the wafer stage WST is stepped to a position for starting exposure for the next shot. When exposure with respect to all the shot positions is finished, the wafer W is replaced by another wafer W, by the wafer replacing apparatus (not shown). The wafer replacing apparatus is arranged at a position away from the wafer stage WST, and comprises a wafer transport system such as a wafer loader or the like for performing delivery of the wafer W.

The position of the surface of the wafer W in the Z direction is measured by a main focus detection system. For the main focus detection system, an oblique incident radiation type focus detection system comprising an irradiation optical system 60a which irradiates imaging beams or parallel beams for forming a pinhole image or a slit image from an oblique direction with respect to the optical axis AX toward an imaging plane of the projection optical system PL, and a light receiving optical system 60b which receives beams of light of the imaging beams or parallel beams reflected on the surface of the wafer W (or the surface of a fiducial board WFB described later) is used, and a signal from the light receiving optical system 60b is supplied to the main control unit 13. The main control unit 13 controls the Z position of the wafer W via the drive system 25, so that the surface of the wafer W always comes to the best image plane of the projection optical system PL, based on the signal from the light receiving optical system 60b.

The fiducial board WFB having various kinds of fiducial marks formed thereon, such as wafer fiducial marks WFM1, WFM2 and WFM3 for reticle alignment and baseline measurement described later, is provided on the wafer stage WST. The surface position of the fiducial board WFB (the position in the Z direction) is assumed to be substantially the same as the surface position of the wafer W.

A configuration example of the wafer fiducial mark WFM1 formed on the fiducial board WFB is shown in FIG. 4. The wafer fiducial mark WFM1 includes a plurality of (here, two) marks having different reflectance characteristics with respect to the illumination beam IL. Specifically, the wafer fiducial mark WFM1 comprises a first fiducial mark FMa having a mark pattern MPa formed of chromium on a base area formed of glass, and a second fiducial mark FMb having a mark pattern MPb formed of glass on a base area formed of chromium. The mark pattern MPa and the mark pattern MPb are formed in the same shape, though the material is different as described above, and are arranged on the fiducial board WFB, with a predetermined distance therebetween in a predetermined direction (for example, in the Y direction). In the reticle alignment and the baseline measurement described later, any one of these plurality of fiducial marks FMa and FMb is selectively positioned within the observation field of the reticle alignment microscopes 22A and 22B and observed. Other wafer fiducial marks WFM2 and WFM3 have the same configuration, and the relative positions (separation direction and separation distance) between the mark pattern MPa and the mark pattern MPb included therein are the same as those included in the wafer fiducial mark WFM1. In this embodiment, the fiducial board WFB having the wafer fiducial marks WFM1 to WFM3 formed thereon is provided on the wafer stage WST, but this fiducial board WFB may be at another position (for example, on the wafer holder 52 or on the movable mirror 53) so long as it is on the stage board BS.

Returning to FIG. 2, for the wafer alignment sensor 27, there is used an image processing type imaging sensor known in Japanese Unexamined Patent Application, First Publication No. Hei 4-65603, which has an index, being a detection reference, and detects the position of the wafer alignment mark on the wafer W or the wafer fiducial mark WFM on the fiducial board WFB, based on the index. The detection value of the wafer alignment sensor 27 is supplied to the main control unit 13. A sensor of other types, for example, a laser scan type sensor or a laser interference type sensor known in Japanese Unexamined Patent Application, First Publication No. Hei 10-141915 may be used for the wafer alignment sensor.

The reticle alignment microscope 22A has a prism 28A, a semi-transparent mirror 30A and an observation system 32A. This reticle alignment microscope 22A is integrated by means of a case, and is constructed so as to be freely movable in a direction of arrows A, A′ in FIG. 2 by a drive system 26A. When performing reticle alignment and baseline measurement, the main control unit 13 drives the reticle alignment microscope 22A in the direction of arrow A via the drive system 26A to position it at a position shown in FIG. 2, and when the reticle alignment and baseline measurement are finished, drives the reticle alignment microscope 22A in the direction of arrow A′ via the drive system 26A to withdraw it to a predetermined withdrawal position, so as not to become an obstruction to the exposure.

Similarly, the other reticle alignment microscope 22B also has a prism 28B, a semi-transparent mirror 30B and an observation system 32B, and is integrated by means of a case, and constructed so as to be freely movable in a direction of arrows B, B′ in FIG. 2 by a drive system 26B. When performing reticle alignment and baseline measurement, the main control unit 13 similarly positions the reticle alignment microscope 22B at a position shown in FIG. 2, and when the reticle alignment and baseline measurement are finished, withdraws the reticle alignment microscope 22B to a predetermined withdrawal position. In this embodiment, the reticle alignment microscope 22 guides the exposure light (illumination beam IL) used as the illumination for detection, via the mirror 37 and the prism 28. However, the present invention is not limited thereto, and for example, after the illumination beam is diverged by a mirror or the like, the illumination beam may be guided into the reticle alignment microscope 22 using an optical fiber, to be irradiated onto the reticle via the imaging optical system 40 and the semi-transparent mirror 30 described later. By having such a configuration, the prism 28 is not required, and the drive system 26 needs only to drive the semi-transparent mirror 30A (30B) in a direction of arrow C′ (D′) to withdraw it to a predetermined withdrawal position, without moving the whole microscope 22 to the withdrawal position.

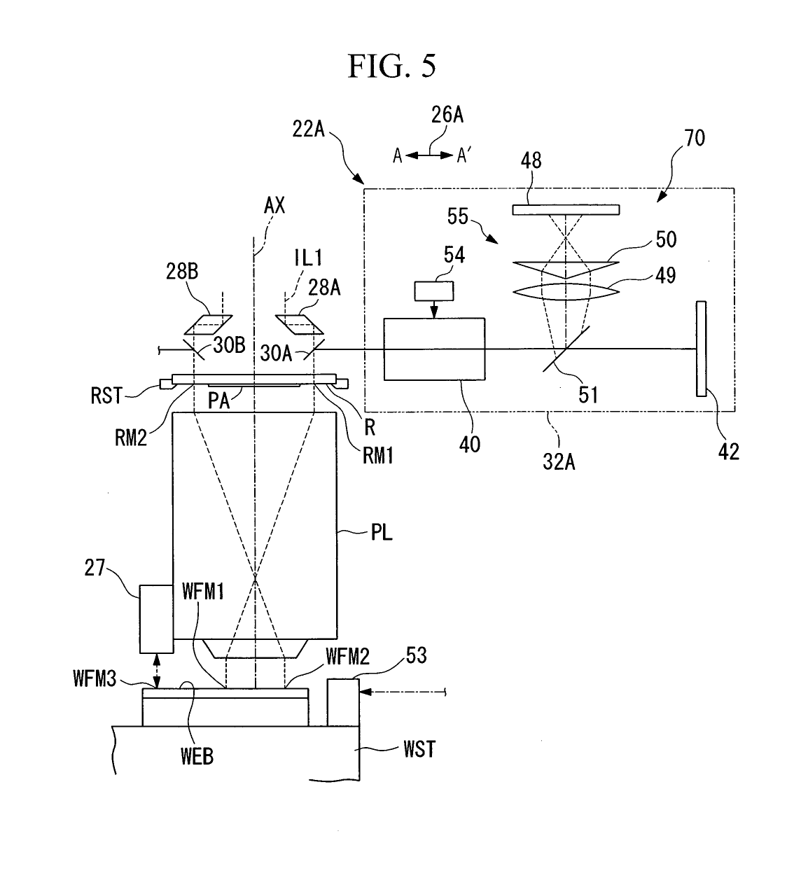

The configuration and operation of one reticle alignment microscope 22A will be described in detail based on FIG. 5. In FIG. 5, the projection optical system PL, the fiducial board WFB, and the reticle alignment microscope 22A in FIG. 2 are shown in an enlarged scale. As shown in FIG. 2, the prism 28A is for guiding the illumination beam IL onto the reticle mark RM1 on the reticle R. This is because the reticle mark is provided outside of the pattern area PA, and this portion is a portion which is generally not required to be illuminated, and hence, a part of beams of the illumination beam IL (hereunder this beam is referred to as “IL1” for convenience sake) is guided from the normal illumination area, in order to eliminate useless load and illuminance of the illumination system.

The semi-transparent mirror 30A is arranged on the optical path of the beam IL1, and the beam IL1 guided by the prism 28A illuminates the reticle mark RM1 via the semi-transparent mirror 30A, and also illuminates the wafer fiducial mark WFM1 on the fiducial board WFB via the reticle R and the projection optical system PL. The reflected light from the reticle mark RM1 and the wafer fiducial mark WFM1 are respectively reflected by the semi-transparent mirror 30A, and the reflected beam thereof enters into the observation system 32A.

The observation system 32A comprises the imaging optical system 40, a semi-transparent mirror 51, a lens 49, a pupil-split prism 50, and a CCD sensor 42.

Of these, the imaging optical system 40, the semi-transparent mirror 51 and the CCD sensor 42 constitute a detection optical system for detecting the images of the reticle mark RM1 and the wafer fiducial mark WFM1. In other words, as described above, the reflected beams from the reticle mark RM1 and the wafer fiducial mark WFM1 portion which are respectively reflected by the semi-transparent mirror 30A, pass through the semi-transparent mirror 51, and are respectively imaged on the best image plane (focal position) of the imaging optical system 40. In this case, since the reticle pattern face and the fiducial board WFB face are originally set to be in a conjugate relation, if it is assumed that the reticle pattern face and the light receiving plane of the CCD sensor 42 are conjugate, the images of the marks RM1 and WFM1 are respectively formed in the best imaging condition on the light receiving plane of the CCD sensor 42, and the marks RM1 and WFM1 are photoelectrically detected by the CCD sensor 42. Therefore, the main control unit 13 (see FIG. 2) detects the relative positions of images of the marks RM1 and WFM1, based on the output of the CCD sensor 42 (output of the reticle alignment microscope 22A).

For the imaging optical system 40, an optical system capable of changing the focal length, that is, a so-called internal focusing type optical system is used herein. Moreover, the lens 49 which re-forms the image of the reticle mark RM on the CCD sensor 48 via the semi-transparent mirror 51, the pupil-split prism 50 provided on a pupil plane between the lens 49 and the CCD sensor 48, the CCD sensor 42 and the like constitute a focus detection system 70 serving as a defocus detection unit which detects defocus of the imaging optical system 40. This focus detection system 70 uses the exposure illumination beam IL as a detection beam for detecting the focal position. In this focus detection system 70, the reflected beam from the reticle mark RM is divided into two by the pupil-split prism 50, and then imaged on the light receiving plane of the CCD sensor 48. At this time, if the focal position of the imaging optical system 40 is shifted, the spacing between the imaging positions of the divided two beams on the CCD sensor 48 changes. The main control unit 13 detects the defocus based on the change of this spacing. Therefore, the main control unit 13 measures the defocus of the imaging optical system 40 based on the output of the CCD sensor 48, and drives a lens group (not shown) inside the imaging optical system 40 via the drive system 54, so that the focal point of the imaging optical system 40 can be matched with the reticle pattern face and the light receiving plane of the CCD sensor 42. In this case, the main control unit 13 drives the lens group inside the imaging optical system 40 so that the spacing between the imaging positions on the CCD sensor 48 is constant at all times, to thereby make the focal position coincide with the CCD sensor 42. In other words, the focus detection system 70, the main control unit 13 and the drive system 54 constitute a focus adjusting system 55 which adjusts the focal state of the reticle alignment microscopes 22A and 22B.

The other reticle alignment microscope 22B constituted by the prism 28B, the semi-transparent mirror 30B and the observation optical system 32B has the same configuration and function as those of the reticle alignment microscope 22A, and detects the relative misalignment of the reticle mark RM2 on the reticle R and the wafer fiducial mark WFM2, in a state without defocus of the imaging optical system.

The control system is mainly composed of the main control unit 13 in FIG. 2. The main control unit 13 is formed of a so-called microcomputer (or a minicomputer) comprising a CPU (central processing unit), a ROM (read only memory) and a RAM (random access memory), and controls alignment of the reticle R and the wafer W, stepping of the wafer W, exposure timing and the like in a generalized manner, so that the exposure operation is performed accurately. The main control unit 13 also controls the whole apparatus in a generalized manner, as well as adjusting the focal position of the reticle alignment microscopes 22A and 22B as mentioned above.

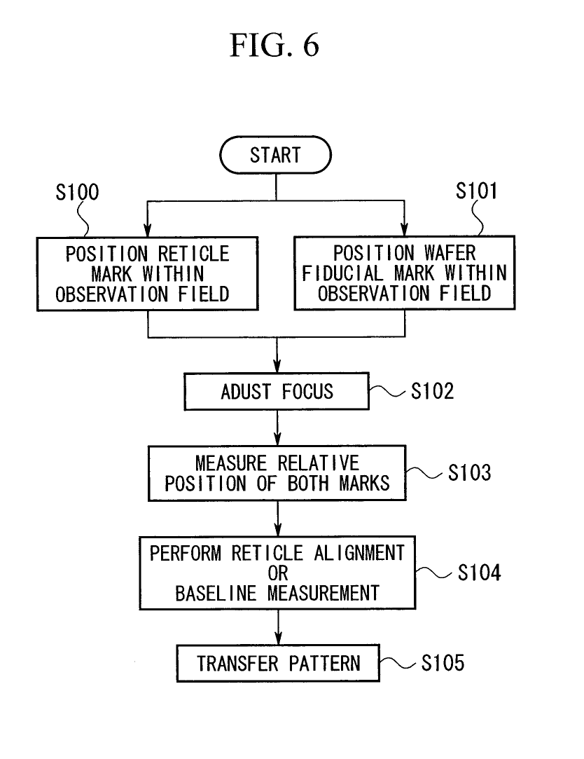

The operation at the time of superposition exposure by the exposure apparatus 10 in this embodiment constituted in the above manner, particularly the operation accompanying the baseline measurement will be described with reference to the flowchart in FIG. 6.

It is assumed that a reticle R is mounted on the reticle stage RST, and a pattern has already been formed on the wafer W in the previous steps, and the wafer alignment mark (not shown) has already been formed together with this pattern.

At first, the main control unit 13 shifts the reticle alignment microscopes 22A and 22B via the drive systems 26A and 26B, based on a predetermined design value, and positions the reticle marks RM1 and RM2 on the reticle R within the observation field thereof (step 100).

Moreover, the main control unit 13 shifts the wafer stage WST based on a predetermined design value, while monitoring the output of the laser interferometer 56, so that the central points of the wafer fiducial marks WFM1 and WFM2 on the fiducial board WFB are located on the optical axis AX of the projection optical system PL. At this time, the main control unit 13 selectively positions any one of the plurality of fiducial marks FMa and FMb (see FIG. 4) included in the respective wafer fiducial marks WFM1 and WFM2, within the observation field of the reticle alignment microscopes 22A and 22B, via the drive system 25 based on the reflectance characteristic of the reticle R with respect to the illumination beam IL (beams IL1) (step 101).

Specifically, when the reflectance of the reticle marks RM1 and RM2 on the reticle R mounted on the reticle stage RST is not smaller than a predetermined reflectance, such as with a high reflectance reticle (for example, the reflectance of the mark is about 30%), the drive system 25 shifts the wafer stage WST, to selectively position the first fiducial mark FMa of the plurality of fiducial marks FMa and FMb within the observation field thereof. On the contrary, when the reflectance of the reticle marks RM1 and RM2 on the reticle R mounted on the reticle stage RST is smaller than the predetermined reflectance, such as with a low reflectance reticle (for example, the reflectance of the mark is about 5 to 10%), or a halftone reticle (for example, the reflectance of the mark is about 5 to 10%), the drive system 25 selectively positions the second fiducial mark FMb within the observation field thereof. The reflectance, being the selection criterion, is set so that when the reticle mark and the wafer fiducial mark are observed at the same time, the contrast of the reticle mark becomes high. The information relating to the characteristic peculiar to the reticle, such as reflectance characteristic, is stored in advance in the main control unit 13 associated with each reticle. The state in which the reticle alignment microscopes 22A and 22B are positioned is shown in FIG. 2 and FIG. 5.

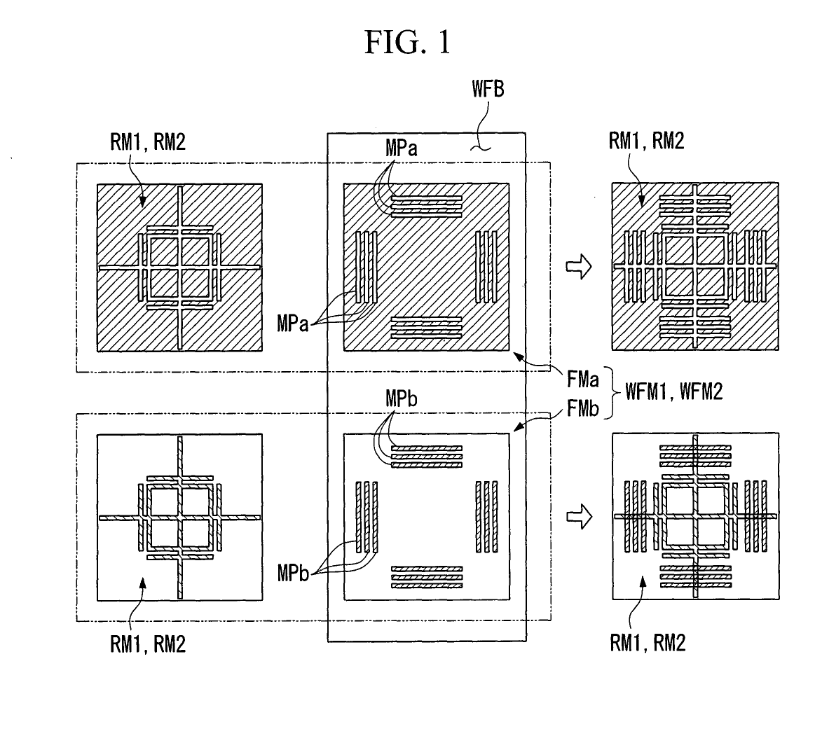

The illumination beam IL is guided onto the reticle R, using the reticle alignment microscopes 22A and 22B, and the reticle marks RM1 and RM2 on the reticle R and the wafer fiducial marks WFM1 and WFM2 on the fiducial board WFB are observed at the same time. At this time, as shown in FIG. 1, when the reflectance of the reticle marks RM1 and RM2 on the reticle R is high, and the first fiducial mark FMa is arranged within the observation field of the reticle alignment microscopes 22A and 22B, relatively strong beams are generated from the reticle marks RM1 and RM2 as reflected beams, and relatively weak beams are generated from the base area of glass in the first fiducial mark FMa. Therefore, the beams generated from the reticle marks RM1 and RM2 are observed bright, and the beams generated from the base area of the wafer fiducial marks WFM1 and WFM2 are observed darker than those from the reticle marks RM1 and RM2. As a result, the reticle marks RM1 and RM2 are observed with high contrast. On the contrary, as shown in FIG. 1, when the reflectance of the reticle marks RM1 and RM2 on the reticle R is low, and the second fiducial mark FMb is arranged within the observation field of the reticle alignment microscopes 22A and 22B, relatively strong beams are generated from the base area of chromium in the second fiducial mark FMb, though the intensity of the reflected beams generated from the reticle marks RM1 and RM2 is relatively weak. As a result, the beams generated from the reticle marks RM1 and RM2 are observed dark, and the beams generated from the base area of the wafer fiducial marks WFM1 and WFM2 are observed brighter than those from the reticle marks RM1 and RM2. That is to say, the reticle marks RM1 and RM2 are observed with high contrast, also in this case.

Subsequently, the main control unit 13 adjusts the focal state of the reticle alignment microscopes 22A and 22B with respect to the reticle marks RM1 and RM2 by the focus adjusting system 55, and also adjusts the focal state of the projection optical system PL with respect to the wafer fiducial mark WFM3 on the wafer stage WST by the main focus detection system (60a, 60b) (step 102).

Based on the result of simultaneous observation of the reticle marks RM1 and RM2, and the wafer fiducial marks WFM1 and WFM2, the main control unit 13 measures the relative positions of the marks RM1 and WFM1 and the relative positions of the marks RM2 and WFM2 (step 103). As the initialization of the reticle R, based on the measurement results of the relative positions, positioning of the reticle R with respect to the projection optical system PL, that is, reticle alignment can be performed.

The main control unit 13 observes the wafer fiducial mark WFM3 on the fiducial board WFB, using the wafer alignment sensor 27, simultaneously with the relative position measurement, to measure the relative positions of the wafer fiducial mark WFM3 and the index of the wafer alignment sensor 27. The wafer fiducial marks WFM1, WFM2 and WFM3 on the fiducial board WFB are respectively formed at a position accurately in accordance with the position in the predetermined design. Therefore, the main control unit 13 can calculate the relative distance (a so-called baseline quantity) between the projected position of the pattern on the reticle R and the index of the wafer alignment sensor 27, via the fiducial board WFB, from the arrangement information in the design and the relative position obtained by the above operation (baseline measurement, step 104).

Thereafter, the main control unit 13 sequentially measures the position of the wafer alignment mark added to the plurality of shot areas on the wafer W, using the wafer alignment sensor 27, to obtain all shot array data on the wafer W, by a so-called EGA (enhanced global alignment) method. The main control unit 13 controls the laser emission from the light source 12 to perform exposure by a so-called step and repeat method, while sequentially positioning the shot area on the wafer W immediately below the projection optical system PL (exposure position), according to the array data (step 105). The EGA and the like are known in Japanese Unexamined Patent Application, First Publication No. Sho 61-44429, and hence detailed explanation is omitted here.

According to this embodiment, by selecting marks from a plurality of fiducial marks FMa and FMb having different reflectance, as the wafer fiducial marks WFM1 and WFM2 to be observed together with the reticle marks RM1 and RM2, based on the reflectance characteristics of the reticle marks RM1 and RM2 with respect to the illumination beam IL (beam IL1), the reticle marks RM1 and RM2 can be observed with high contrast, corresponding to various reticles R, for example, when the intensity of the beams generated from the reticle marks RM1 and RM2 is weak. Therefore, the influence due to the characteristic peculiar to the reticle R is suppressed, the relative positions of the reticle marks RM1 and RM2 and the wafer fiducial marks WFM1 and WFM2 can be measured accurately, and the wafer W can be accurately positioned at the exposure position.

As shown in FIG. 1, since the degree of brightness of the observed reticle marks RM1 and RM2 in a case where a mark arranged within the observation field of the reticle alignment microscopes 22A and 22B is designated as the fiducial mark FMa, is inverted in a case where the mark is designated as the fiducial mark FMb, the processing method of the imaging signal changes. However, the main control unit 13 handles this change by processing the signal based on the result of selecting any one of the plurality of fiducial marks FMa and FMb. As the method of selecting any one of the plurality of fiducial marks FMa and FMb based on the reflectance characteristics of the reticle marks RM1 and RM2, a detection unit for detecting the characteristic of the reticle R may be provided to perform the selection based on the detection result of the characteristic by the detection unit, or the selection may be performed by detecting the reticle marks RM1 and RM2 with respect to the plurality of fiducial marks FMa and FMb, respectively, by the reticle alignment microscopes 22A and 22B, and comparing the contrast of the reticle marks RM1 and RM2 at that time. Moreover, the shape and the number of the plurality of fiducial marks FMa and FMb is not limited to that shown in FIG. 4.

When measuring the relative positions of the reticle marks RM1 and RM2 and the wafer fiducial marks WFM, the main control unit 13 performs adjustment of the focal state (hereunder referred to as RA-AF) of the imaging optical system 40 constituting the reticle alignment microscopes 22A and 22B with respect to the reticle marks RM1 and RM2 by the focus adjusting system 55 (step 102 shown in FIG. 6). As described above, in this embodiment, since the reticle marks RM1 and RM2 can be observed with high contrast, corresponding to various reticles R, without depending on the characteristic peculiar to the reticle, in this RA-AF, the focal state of the reticle alignment microscopes 22A and 22B can be accurately detected, and focus adjustment can be carried out accurately. Since this RA-AF operation is for adjusting the focal state with respect to the reticle marks RM1 and RM2, the fiducial marks WFM1 and WFM2 on the wafer stage WST are not necessarily observed, as described below.

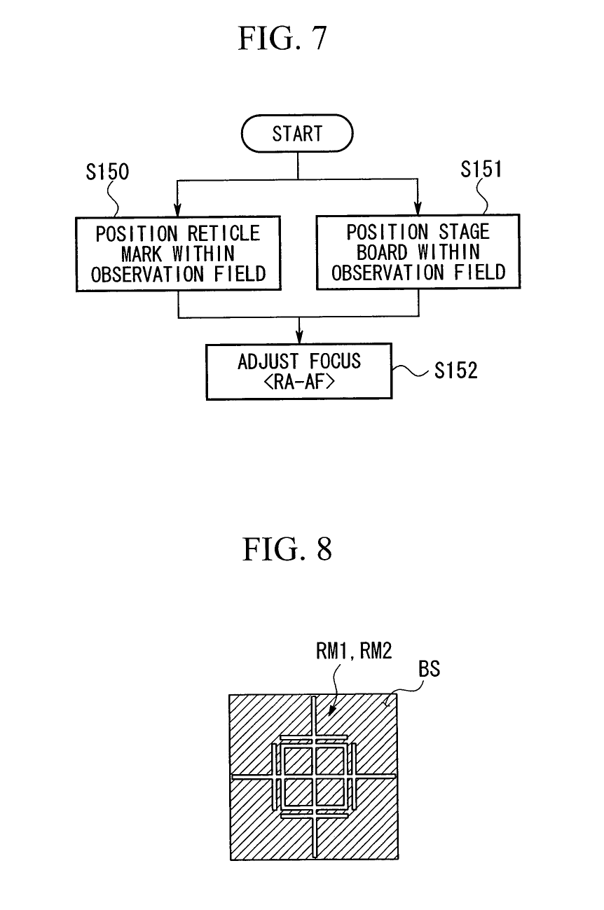

The flowchart shown in FIG. 7 shows one example of a procedure of the RA-AF operation for positioning the surface of the stage board BS, on which the wafer stage WST is mounted, within the observation field of the reticle alignment microscopes 22A and 22B, instead of the fiducial marks WFM1 and WFM2 on the wafer stage WST.

In other words, in the flowchart shown in FIG. 7, the main control unit 13 shifts the reticle alignment microscopes 22A and 22B via the drive systems 26A and 26B, and positions the reticle marks RM1 and RM2 on the reticle R within the observation field thereof (step 150), and also shifts the wafer stage WST via the drive system 25 so that the surface of the stage board BS is exposed below the projection optical system PL (step 151). The main control unit 13 then irradiates the illumination beam IL onto the reticle R, to observe the reticle marks RM1 and RM2 on the reticle R and the surface of the stage board BS at the same time, by using the reticle alignment microscopes 22A and 22B. The surface of the stage board BS is plated with black chromium or the like, and hence the reflectance with respect to the illumination beam IL is very low. Therefore, as shown in FIG. 8, the beams generated from the reticle marks RM1 and RM2 are observed brighter than the surface of the stage board BS. Subsequently, the main control unit 13 adjusts the focal state of the reticle alignment microscopes 22A and 22B with respect to the reticle mark RM by the focus adjusting system 55, with the reticle marks RM1 and RM2 and the surface of the stage board BS being positioned within the observation field of the reticle alignment microscopes 22A and 22B (step 152).

Here, the RA-AF operation by the focus adjusting system 55 consumes much time as compared with the focus adjusting operation by the main focus detection system (60a, 60b). Therefore, as described above, by positioning the surface of the stage board BS within the observation field of the reticle alignment microscopes 22A and 22B, instead of the wafer fiducial marks WFM1 and WFM2 on the wafer stage WST, the RA-AF operation is performed while executing the replacement operation of the wafer W mounted on the wafer stage WST, to thereby suppress a decrease in the throughput. The adjustment of the focal state of the projection optical system PL with respect to the wafer fiducial mark WFM3 on the wafer stage WST can be performed by the main focus detection system (60a, 60b), after the replacement operation of the wafer W.

The RA-AF operation is performed, for example, at the time of reticle alignment (reticle replacement) for initialization of the reticle R, and at the time of baseline measurement. The reason why the focal state of the reticle alignment microscopes 22A and 22B adjusted at the time of initialization is again adjusted at the time of baseline measurement is as described below. That is, as described above, since the reticle alignment microscopes 22A and 22B are withdrawn so as not to become an obstruction to the exposure, a deviation may occur, for example, in the position or angle of the semi-transparent mirrors 30A and 30B due to the shift, and there is a possibility that the focal state of the reticle alignment microscopes 22A and 22B varies. Therefore, the RA-AF operation is performed at an optional timing. In other words, the RA-AF operation may be performed every time the wafer W is replaced, or may be performed every time a predetermined number of wafers is replaced.

In the RA-AF operation shown in FIG. 7, since it is possible to perform the operation during replacement of the wafer W, there is an advantage in that the throughput can be improved. However, the intensity of the beams from the reticle marks RM1 and RM2 may be weak, depending on the reticle R, and hence there is a possibility of causing a decrease in the detection accuracy of the focal state. Therefore, as described below, not observing the reticle marks RM1 and RM2 in the RA-AF operation is also possible.

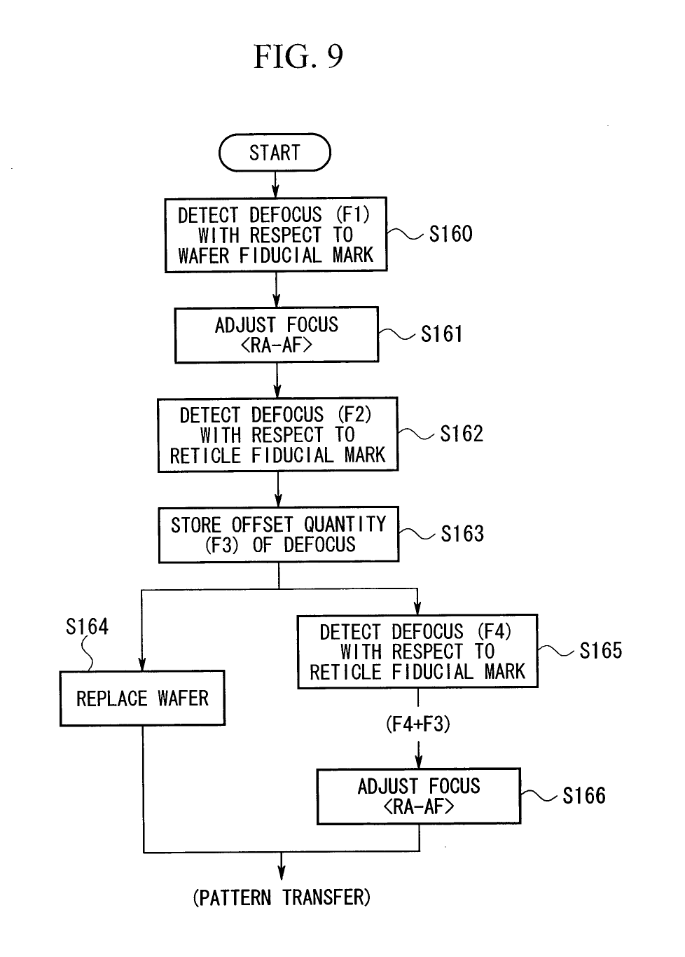

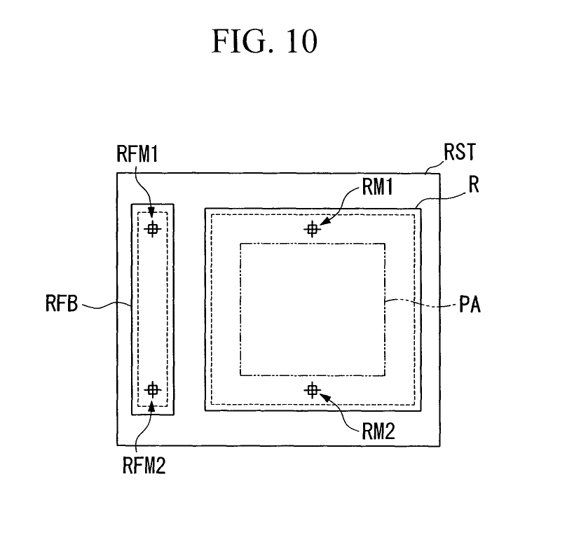

The flowchart shown in FIG. 9 shows one example of a procedure in which the RA-AF is performed, by observing the fiducial mark (reticle fiducial mark) for the reticle, formed on the fiducial board provided on the reticle stage, instead of the reticle mark on the reticle.

FIG. 10 shows the situation of the reticle fiducial board RFB provided on the reticle stage RST. The fiducial board RFB is formed of a transparent member having the same material as that used for example in a high reflectance reticle, and is fixed at a position away from the reticle R on the reticle stage RST. In the fiducial board RFB, the face on which the fiducial mark for the reticle (reticle fiducial mark RFM1, RFM2) is formed is substantially the same face as the pattern face of the reticle R. The reticle fiducial marks RFM1 and RFM2 are formed as a shading portion consisting of chromium on a glass plate, being the parent material, and the shape is assumed to be the same as the shape of the reticle marks RM1 and RM2 shown in FIG. 3, formed on the reticle R. The material of the fiducial board RFB is selected so that the reflectance of the reticle marks RM1 and RM2 with respect to the illumination beam IL becomes high.

Returning to FIG. 9, the main control unit 13 shifts the wafer stage WST via the drive system 25, to position the wafer fiducial marks WFM1 and WFM2 on the wafer stage WST within the observation field of the reticle alignment microscopes 22A and 22B, and irradiates the illumination beam IL onto the wafer fiducial marks WFM1 and WFM2. The main control unit 13 then detects defocus (F1) of the reticle alignment microscopes 22A and 22B with respect to the wafer fiducial marks WFM1 and WFM2 on the wafer stage WST, via the reticle R by the focus detection system 70 (step 160). As described above, the face of the reticle R on which the reticle marks RM1 and RM2 are formed (reticle pattern face), and the fiducial board WFB on which the wafer fiducial marks WFM1, WFM2 and WFM3 are formed on the wafer stage WST are set originally to be in a conjugate relation. Therefore, detection of defocus of the reticle alignment microscopes 22A and 22B with respect to the wafer fiducial marks WFM1 and WFM2 corresponds to the detection of defocus of the reticle alignment microscopes 22A and 22B with respect to the reticle marks RM1 and RM2.

Subsequently, the main control unit 13 adjusts the focal state of the reticle alignment microscopes 22A and 22B with respect to the wafer fiducial marks WFM1 and WFM2 by the focus adjusting system 55, based on the detection result of the defocus (step 161). At this time, as described above, since the detection of defocus of the reticle alignment microscopes 22A and 22B with respect to the wafer fiducial marks WFM1 and WFM2 corresponds to the detection of defocus of the reticle alignment microscopes 22A and 22B with respect to the reticle marks RM1 and RM2, the focal state of the reticle alignment microscopes 22A and 22B is adjusted with respect to the reticle marks RM1 and RM2.

In this manner, the focal state of the reticle alignment microscopes 22A and 22B can be adjusted with respect to the reticle marks RM1 and RM2, by observing the wafer fiducial marks WFM1 and WFM2 via the reticle R. However, as described above, since the RA-AF operation by the focus adjusting system 55 consumes relatively much time, it is desired to limit these step 160 and step 161 to a case where a wafer at the top of the batch is handled, and execute the RA-AF operation using the surface observation of the stage board BS, when other wafers in the middle of the batch are handled.

The main control unit 13 may perform the RA-AF operation during the wafer replacement operation, by storing the focus-adjusted state based on the reticle fiducial marks RFM1 and RFM2, when handling a wafer at the top of the batch, and by detecting the focal state with respect to the reticle fiducial marks RFM1 and RFM2, when handling other wafers.

In other words, the main control unit 13 shifts the reticle stage RST via a drive system (not shown), with the focal state of the reticle alignment microscopes 22A and 22B adjusted with respect to the wafer fiducial marks WFM1 and WFM2 in step 161, and positions the reticle fiducial marks RFM1 and RFM2 formed on the fiducial board RFB provided on the reticle stage RST within the observation field of the reticle alignment microscopes 22A and 22B. The main control unit 13 then irradiates the illumination beam IL onto the reticle fiducial marks RFM1 and RFM2, to detect defocus (F2) of the reticle alignment microscopes 22A and 22B with respect to the reticle fiducial marks RFM1 and RFM2 on the reticle stage RST by the focus detection system 70 (step 162).

The main control unit 13 determines a difference between defocus (F1) of the reticle alignment microscopes 22A and 22B with respect to the wafer fiducial marks WFM1 and WFM2 detected in step 160, and defocus (F2) of the reticle alignment microscopes 22A and 22B with respect to the reticle fiducial marks RFM1 and RFM2 detected in step 162 (F3=F1−F2), and stores the difference as an offset quantity of defocus in a memory section in the main control unit 13 (step 163).

While replacing the wafer W mounted on the wafer stage WST with another wafer W by a wafer replacing apparatus (not shown) (step 164), the main control unit 13 again shifts the reticle stage RST via the drive system (not shown), to position the reticle fiducial marks RFM1 and RFM2 within the observation field of the reticle alignment microscopes 22A and 22B, and detects defocus (F4) of the reticle alignment microscopes 22A and 22B with respect to the reticle fiducial marks RFM1 and RFM2 (step 165).

The main control unit 13 adds the offset quantity (F3) stored in step 163 to the defocus (F4) of the reticle alignment microscopes 22A and 22B with respect to the reticle fiducial marks RFM1 and RFM2, to calculate defocus (F3+F4) of the reticle alignment microscopes 22A and 22B with respect to the reticle marks RM1 and RM2 at this time, and based on the calculation result, adjusts the focal state of the reticle alignment microscopes 22A and 22B with respect to the reticle marks RM1 and RM2 (step 166).

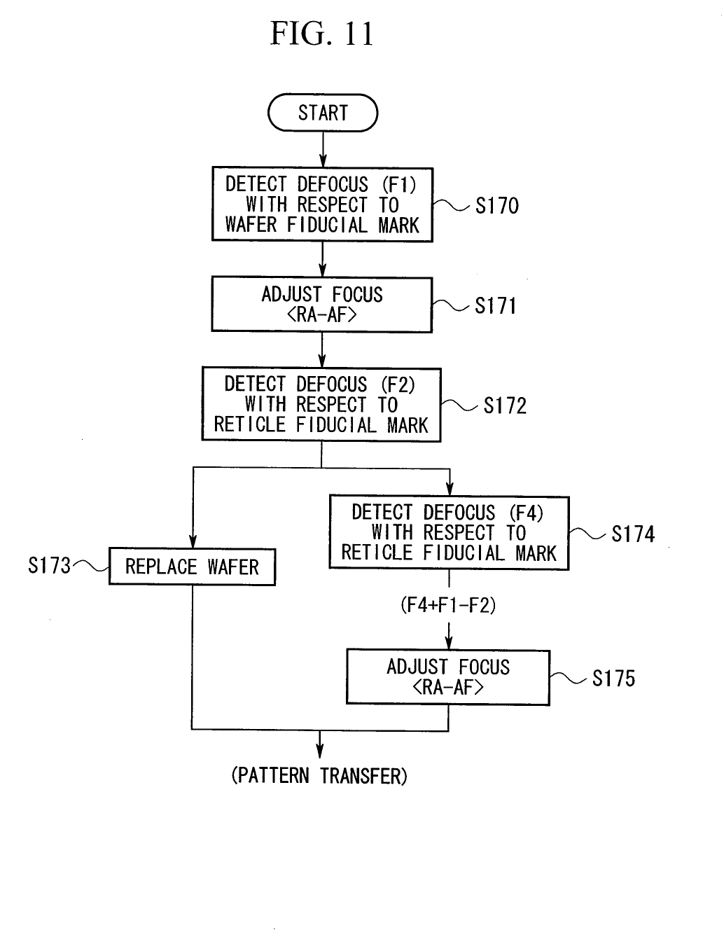

In this manner, in the RA-AF operation shown in the flowchart in FIG. 9, the reticle marks RM1 and RM2 are not observed. Therefore, a decrease in measurement accuracy due to the characteristic peculiar to the reticle R is avoided, and the RA-AF operation can be performed accurately. In the flowchart in FIG. 9, the offset quantity of defocus is calculated and stored in advance in step 163, but as shown in the flowchart in FIG. 11, this calculation operation of the offset quantity may be omitted, and after defocus (F4) of the reticle alignment microscopes 22A and 22B with respect to the reticle fiducial marks RFM1 and RFM2 is calculated during wafer replacement, defocus (F4+F1−F2) of the reticle alignment microscopes 22A and 22B with respect to the reticle marks RM1 and RM2 at this time may be calculated to perform adjustment of the focal state (step 175).

Moreover, the procedure shown in the flowchart in FIG. 9 or FIG. 11 and the procedure shown in the flowchart in FIG. 7 may be combined to perform the RA-AF operation.

The operation procedure shown in the embodiment, or the various shapes and combinations of the respective constituents are an example only, and can be variously changed based on the process condition and design requirements without departing from the gist of the present invention. The present invention includes changes as described below.

For example, in the embodiment, the illumination beam for exposure is used for the illumination beam IL for reticle alignment, but a light source for the illumination beam for reticle alignment may be newly provided. In this case, the area on the wafer stage arranged within the observation field of the reticle alignment microscope is determined based on the reflectance characteristic of the reticle mark with respect to the new illumination beam.

The position measuring method according to the present invention is also applicable to misalignment measurement for evaluating whether exposure is accurately performed, or measurement of drawing accuracy of a photo mask on which a pattern image is drawn.

Moreover, the number, arrangement position, and shape of marks formed on the wafer, the reticle and the fiducial board may be determined optionally. Particularly, at least one wafer mark may be provided in the respective shot areas, or the wafer mark may be respectively formed at a plurality of points on the wafer, without providing a wafer mark in each shot area. The mark on the substrate may be a one-dimensional mark or a two-dimensional mark.

The exposure apparatus to which the present invention is applied is not limited to a scanning type exposure apparatus (for example, a step and scan method) wherein a mask (reticle) and a substrate (wafer) are relatively moved with respect to the exposure illumination beam, and may be a stationary exposure method, for example, a step and repeat method, wherein a mask pattern is transferred onto a substrate, with a mask and the substrate being substantially kept stationary. The present invention is also applicable to a step and stitch type exposure apparatus wherein a pattern is respectively transferred in a plurality of shot areas with the peripheral portions thereof overlapping on the substrate. The magnification of the projection optical system PL may be any of a reduction system, an equal magnification or an enlarging system, and may be any of a refraction system, a reflection system or a reflection/refraction system. The present invention is also applicable to a proximity exposure apparatus which does not use the projection optical system.

The exposure apparatus to which the present invention is applied may use, as an exposure illumination beam, not only ultraviolet beams such as a g-line, an i-line, a KrF excimer laser beam, an ArF excimer laser beam, an F2 laser beam or an Ar2 laser beam, but also EUV beams, an X-ray or charged particle beams such as electron beams or ion beams may be used. Moreover, the light source for exposure may be not only a mercury lamp or an excimer laser, but also a YAG laser or a harmonic generator such as a semiconductor laser, an SOR, a laser plasma light source, or an electron gun.

The application of the present invention is not limited to the exposure apparatus for manufacturing semiconductors, and the present invention may be applied to manufacturing liquid crystal display devices, display devices, thin-film magnetic heads, image pick-up devices (CCD or the like), micro-machines, and micro-devices (electronic devices) such as DNA chips, or for manufacturing photo masks or reticles used in the exposure apparatus.

The present invention is applicable not only to the exposure apparatus, but also to other manufacturing apparatus (including inspection devices) used in the device manufacturing step.

When a linear motor is used for the wafer stage and the reticle stage, then either of an air floating type using an air bearing or a magnetic floating type using Lorentz force or reactance force may be used. Moreover, the respective stages may be of a type which moves along a guide, or a guideless type without a guide. When a planar motor is used as the drive system for the stage, one of a magnetic unit (permanent magnet) and an armature unit is connected to the stage, and the other of the magnetic unit and the armature unit may be provided on a moving face side (board, base) of the stage.

The reaction force generated by the movement of the wafer stage may be removed mechanically to the floor (ground) using a frame member, as described in Japanese Unexamined Patent Application, First Publication No. Hei 8-166475. The present invention is also applicable to exposure apparatus having such a construction.

The reaction force generated by the movement of the reticle stage may be removed mechanically to the floor (ground) using a frame member, as described in Japanese Unexamined Patent Application, First Publication No. Hei 8-330224. The present invention is also applicable to exposure apparatus having such a construction.

As described above, the exposure apparatus to which the present invention is applied is produced by assembling various sub-systems including respective constituents mentioned in the claims of this application, so as to maintain a predetermined mechanical accuracy, electrical accuracy and optical accuracy. To ensure these various accuracy, there are performed adjustment for obtaining the optical accuracy with respect to various optical systems, adjustments for obtaining the mechanical accuracy with respect to various mechanical systems and adjustments for obtaining the electrical accuracy with respect to various electric systems, before and after assembly. The assembly process for connecting up from various sub-systems to the exposure apparatus includes mechanical connection, wiring connection of electric circuits and piping connection of pneumatic circuits between various sub-systems. Prior to the assembly process for connecting up from various sub-systems to the exposure apparatus, there is, of course, an assembly process for each sub-system. After the assembly process for connecting up from various sub-systems to the exposure apparatus has been completed, comprehensive adjustment is performed, to thereby ensure various types of accuracy for the overall exposure apparatus. In addition, it is desirable that the production of the exposure apparatus be performed in a clean room wherein the temperature, the degree of cleanness and the like are controlled.

A semiconductor device is produced through a step of designing the function and performance of the device, a step of producing masks (reticles) based on the designing step, a step of producing wafers from a silicon material, a wafer processing step of exposing a pattern of a reticle by means of the exposure apparatus described above, a device assembly step (including a dicing step, bonding step and packaging step), and an inspection step.

### INDUSTRIAL APPLICABILITY

According to the position measuring method in the first to the twenty-second embodiments, any one of a plurality of fiducial marks formed on the substrate stage side is selectively positioned within the observation field the same as that of the mask mark, based on the characteristic of the mask mark with respect to the illumination beam. As a result a decrease in contrast in the mask mark to be observed is suppressed. Consequently, dependency on the characteristic peculiar to the mask can be suppressed, thereby enabling improvement in the measurement accuracy.

According to the exposure apparatus in the twenty-third embodiment and in the twenty-fifth to the thirty-fourth embodiments, the exposure accuracy can be improved by positioning the substrate at an exposure position, based on the accurately measured position information.

According to the device manufacturing method in the twenty-fourth embodiment, a device having improved accuracy of the formed pattern can be provided by improving the exposure accuracy.

1. (cancel)

2. (cancel)

3. (cancel)

4. A position measuring method in which a mask mark formed on a mask mounted on a mask stage and a fiducial mark formed on a fiducial member provided on a substrate stage are illuminated by an illumination beam, beams generated from said both marks are observed by using an observation system, and a relative positional relationship between said mask mark and said fiducial mark is detected based on observation results, said position measuring method comprising:
a first step of positioning a first mark on said mask stage within an observation field of said observation system;
a second step of selectively positioning an area arranged on said substrate stage side with respect to said mask stage and observed together with said first mark by said observation system within said observation field based on the characteristic of said first mark with respect to said illumination beam, and
a third step of detecting said first mark via said observation system by using said illumination beam after said first step and said second step to detect a focal state of said observation system with respect to said first mark.

5. A position measuring method according to claim 4, wherein said fiducial mark comprises a plurality of fiducial marks having different characteristics with respect to said illumination beam, and
the area positioned within said observation field in said second step is one of said plurality of fiducial marks.

6. A position measuring method according to claim 5, wherein said plurality of fiducial marks include a first fiducial mark in which a mark pattern formed of chromium is formed on a base area formed of glass, and a second fiducial mark in which a mark pattern formed of glass is formed on a base area formed of chromium.

7. A position measuring method according to claim 5, wherein said first mark is said mask mark.

8. A position measuring method according to claim 4, wherein the area positioned within said observation field in said second step is a board on which said substrate stage is mounted.

9. A position measuring method according to claim 8, wherein, when a replacement operation of said substrate to be mounted on said substrate stage is carried out, a detection operation of the focal state of said observation system with respect to said first mark is performed.

10. A position measuring method according to claim 9, wherein said first mark is said mask mark.

11. A position measuring method according to claim 9, wherein said first mark is a fiducial mark formed on a fiducial member provided on said mask stage.

12. A position measuring method according to claim 1, wherein said characteristic includes a reflectance characteristic with respect to said illumination beam.

13. A position measuring method according to claim 4, wherein said characteristic includes a reflectance characteristic with respect to said illumination beam.

14. A position measuring method in which a mask mark formed on a mask mounted on a mask stage and a fiducial mark formed on a fiducial member provided on a substrate stage are illuminated by an illumination beam, beams generated from said both marks are observed by using an observation system, and a relative positional relationship between said mask mark and said fiducial mark is detected based on observation results, said position measuring method comprising:
a first step of replacing a substrate mounted on said substrate stage with another substrate, and
a second step of detecting a first mark on said mask stage via said observation system by using said illumination beam while performing a replacement operation of said substrate in said first step to detect a focal state of said observation system with respect to said first mark.

15. A position measuring method according to claim 14, wherein
said first step is carried out without accompanying a mask replacement operation for replacing a mask mounted on said mask stage by another mask, and
said second step is carried out every time the replacement operation of said substrate is performed for a predetermined number of times.

16. A position measuring method according to claim 14, wherein when said first mark is detected in said second step, a board on which said substrate stage is mounted is positioned within said observation field.

17. A position measuring method according to claim 1, wherein said first mark is one of said mask mark and a fiducial mark formed on a fiducial member provided on said mask stage.

18. A position measuring method according to claim 4, wherein said first mark is one of said mask mark and said fiducial mark formed on said fiducial member provided on said mask stage.

19. A position measuring method according to claim 14, wherein said first mark is one of said mask mark and a fiducial mark formed on a fiducial member provided on said mask stage.

20. A position measuring method in which a mask mark formed on a mask mounted on a mask stage and a first fiducial mark formed on a first fiducial member provided on a substrate stage are illuminated by an illumination beam, beams generated from said both marks are observed by using an observation system, and a relative positional relationship between said mask mark and said first fiducial mark is detected based on observation results, said position measuring method comprising:
a first step of illuminating said illumination beam onto said first fiducial mark, and detecting a focal state of said observation system with respect to said first fiducial mark based on the observation results by said observation system;
a second step of illuminating said illumination beam onto a second fiducial mark formed on a second fiducial member provided on said mask stage, and detecting the focal state of said observation system with respect to said second fiducial mark based on the observation results by said observation system;
a third step of replacing a substrate mounted on said substrate stage with another substrate;
a fourth step of detecting said second fiducial mark via said observation system by using said illumination beam, while performing a replacement operation of said substrate in said third step to detect the focal state of said observation system with respect to said second fiducial mark, and
a fifth step of adjusting the focal state of said observation system based on the focal state respectively detected in said first, second and fourth steps.

21. A position measuring method according to claim 21, wherein said second step is performed after the focus of said observation system is adjusted with respect to said first fiducial mark based on the detection result in said first step.

22. A position measuring method according to claim 21, further comprising a sixth step of obtaining a relationship between said focal state detected in said first step and said focal state detected in said second step, wherein
in said fifth step, the focal state of said observation system is adjusted based on said relationship obtained in said sixth step and said focal state detected in said fourth step.

23. An exposure method, comprising the steps of: positioning said substrate at an exposure position based on said relative positional relationship measured by using the position measuring method according to any one of claim 1 through claim 22, and
transferring a pattern on said mask onto said positioned substrate.

24. A device manufacturing method, comprising the step of transferring a device pattern formed on said mask onto said substrate using the exposure method according to claim 23.

25. (cancel)

26. An exposure apparatus in which a mask mark formed on a mask mounted on a mask stage and a fiducial mark formed on a fiducial member provided on a substrate stage are illuminated by an illumination beam, beams generated from said both marks are observed by using an observation system, relative positional relationship between said mask mark and said fiducial mark is detected based on observation results, and a pattern formed on said mask is transferred onto a substrate which is positioned based on the relative positional relationship, wherein
said fiducial mark includes a plurality of fiducial marks having different characteristics with respect to said illumination beam, said exposure apparatus comprising:
a first drive system which positions said mask mark within an observation field of said observation system;
a second drive system which selectively positions one of said plurality of fiducial marks within said observation field based on the characteristic of said first mark with respect to said illumination beam, and
a focus detection system which, after positioning by means of said first and second drive systems, detects said mask mark via said observation system using said illumination beam, to detect a focal state of said observation system with respect to said mask mark.

27. A position measuring method according to claim 25, wherein said characteristic includes a reflectance characteristic with respect to said illumination beam.

28. A position measuring method according to claim 26, wherein said characteristic includes a reflectance characteristic with respect to said illumination beam.

29. An exposure apparatus in which a mask mark formed on a mask mounted on a mask stage and a fiducial mark formed on a fiducial member provided on a substrate stage are illuminated by an illumination beam, beams generated from said both marks are observed by using an observation system, relative positional relationship between said mask mark and said fiducial mark is detected based on observation results, and a pattern formed on said mask is transferred onto a substrate which is positioned based on the relative positional relationship, wherein said exposure apparatus comprising:
a substrate replacing apparatus which replaces a substrate mounted on said substrate stage with another substrate, and
a focus detection system which detects a first mark on said mask stage via said observation system using said illumination beam while performing a replacement operation of said substrate by said substrate replacing apparatus to detect a focal state of said observation system with respect to said first mark.

30. An exposure apparatus according to claim 29, wherein when said first mark is detected by said focus detection system, a board mounted on said substrate stage is positioned within said observation field.

31. An exposure apparatus according to claim 29, wherein said first mark is one of said mask mark and a fiducial mark formed on a fiducial member provided on said mask stage.

32. An exposure apparatus according to claim 30, wherein said first mark is one of said mask mark and a fiducial mark formed on a fiducial member provided on said mask stage.

33. An exposure apparatus in which a mask mark formed on a mask mounted on a mask stage and a first fiducial mark formed on a first fiducial member provided on a substrate stage are illuminated by an illumination beam, beams generated from said both marks are observed by using an observation system, relative positional relationship of said mask mark and said first fiducial mark are detected based on observation results, and a pattern formed on said mask is transferred onto a substrate which is positioned based on the relative positional relationship, said exposure apparatus comprising:
a focus detection system which detects a predetermined mark via said observation system using said illumination beam to detect a focal state of said observation system with respect to said predetermined mark;
a memory unit which obtains relationship between the focal state of said observation system with respect to said first fiducial mark detected by said focus detection system and the focal state of said observation system with respect to a second fiducial mark formed on a second fiducial mark member provided on said mask stage and stores the relationship;
a substrate replacing apparatus which replaces a substrate mounted on said substrate stage with another substrate, and
a focus adjusting system which adjusts the focal state of said observation system using the relationship stored in said memory unit and the focal state of said observation system with respect to said second fiducial mark detected by said focus detection system while performing the replacement operation of said substrate by said substrate replacing apparatus.

34. An exposure apparatus in which a mask mark formed on a mask and a fiducial mark formed on a fiducial member provided on a substrate stage are illuminated by an illumination beam, beams generated from said both marks are observed by using an observation system, relative positional relationship of said mask mark and said fiducial mark is detected based on observation results, and a pattern formed on said mask is transferred onto a substrate which is positioned based on the relative positional relationship,
wherein a plurality of fiducial marks having a different reflectance with respect to said illumination beam are formed on said fiducial member.
